(19) United States
(12) Patent Application Publication
(10) Pub. No.: US 2008/0270241 A1
(43) Pub. Date: Oct. 30, 2008

(54) System And Method For Efficient Allocation Of Rebates

(76) Inventors: Benjamin James Dunlop, Columbus, OH (US); Matthew James Dunlop, Pickerington, OH (US)

Correspondence Address: RONALD J. KOCH, 698 MORRISON RD., SUITE B, COLUMBUS, OH, 43213, US

(21) Appl. No.: 12/139,099

(22) Filed: Jun. 13, 2008

Related U.S. Application Data
(63) Continuation-in-part of application No. 11/956,217, filed on Dec. 13, 2007.
(60) Provisional application No. 60/944,173, filed on Jun. 15, 2007.
(60) Provisional application No. 60/869,783, filed on Dec. 13, 2006.

(51) Int. Cl. G06Q 30/00

(52) U.S. Cl. 705/14

(57) ABSTRACT

A method for efficient allocation of rebates comprising the steps of: providing a server system capable of electronic communication with a user in control of a client system; enabling the user to selectively apportion a rebate in any proportion among those on the list consisting of the user, charities on a pre-established charity list, and other charities; and initiating a funds disbursement in accordance with the apportionment.

The present application is related to the provisional patent application No. 60/869,783 of Matthew James Dunlop, et al, filed Dec. 13, 2006, entitled “System And Method For Efficient Allocation Of Charitable Donations”, and based on which priority is herewith claimed under 35 U.S.C. 119(e) and the disclosure of which is incorporated herein by reference in its entirety as if fully rewritten herein.

The present application is related to the co-pending provisional patent application No. 60/944,173 of Matthew James Dunlop, et al, filed Jun. 15, 2007, entitled “System And Method For Efficient Allocation Of Rebates”, and based on which priority is herewith claimed under 35 U.S.C. 119(e) and the disclosure of which is incorporated herein by reference in its entirety as if fully rewritten herein.

The present application is related to the co-pending patent application Ser. No. 11/956,217 of Matthew James Dunlop, et al, filed Dec. 13, 2007, entitled “System And Method For Efficient Allocation Of Charitable Donations”, and based on which priority is herewith claimed under 35 U.S.C. 120 and the disclosure of which is incorporated herein by reference in its entirety as if fully rewritten herein.

### BACKGROUND AND SUMMARY

The present invention is in the field of charitable monetary contributions to singular or multiple non-profit organizations associated with a rebate incidental to the purchase of consumer products through input of barcodes, promotion codes, product codes, product serial numbers, RFID (radio frequency identification), chemical tag, or other identifiers into the internet (or successor) site.

Rebates are widely known. A typical rebate comprises a consumer purchasing a good that has a rebate associated with it. Thereafter, the consumer completes a rebate form and submits it along with proof of purchase (e.g. UPC label) to the maker of the good. At some point, typically 6 to 8 weeks later, the consumer receives payment in the amount of the rebate.

There are various existing methods relating to charitable donations and/or rewards points. One example is www.Goodsearch.com (trademark) wherein a percentage of proceeds from an internet based word search provided by yahoo (trademark) is diverted to charities that the user is able to choose online. As is known, search engine placement is generally fee based in that advertisers pay an internet service provider (here, yahoo) to show a link to a user upon the occurrence of particular words searched. Goodsearch.com directs some of these funds to charities.

In this example, multiple charities can be chosen for benefit by a web user. The website is driven by search engine partnership. The present invention disclosed herein is novel in that partnerships are based on consumer product purchases or individual retail sales. Also novel is the treatment of transferred funds as a rebate, whereby a choice is made to redeem the funds for personal benefit or direct the funds to a chosen charity.

Another example is Upromise.com (trademark) wherein a small percentage of proceeds from partnered products are diverted to college savings accounts. Transactions are tracked through credit card & loyalty card transactions. Proceeds can be diverted to schools. The present invention disclosed herein is novel in that the full spectrum of US charities other than just schools may become eligible and more forms of purchase tracking are employed to include product/promotion codes and rebate codes. Also novel is that the invention treats transferred funds as a rebate allowing the customers to personally redeem funds or instead transfer funds to a charity, thereby gaining advantages (e.g. in the form of a tax deduction). Rebate programs may specify that rebated funds or merchandise be redeemed equal to the pledged donation value or lesser amount.

Another example is Mycokerewards.com (trademark) wherein codes from drink products are keyed into a website for the collection of points. The points are spent on hats, promotional items, trips, featured products, and contest entry. The present invention disclosed herein is novel in that charities may benefit from the purchase. Also novel is that actual money is transferred in the form of a rebate to either the individual consumer or a charitable organization.

Other examples are Igive.com (trademark) and Charityemporium.com (trademark) whereby an Online charity filter is employed. Consumers shop at top brand retailers like Target (trademark), Barnes and Noble (trademark) and 600 other stores. Benefits are rebated to customers who can channel them to charities of their choice. Tax records are kept and an actual cash rebate can be requested. The present invention disclosed herein is novel in that the sales occur in brick and mortar stores rather than online. Also novel is that rebate transactions are linked to both individual product lines within a store and/or to a rebate code related to the total store purchase.

An invention is presented herein generally described as a “charity rebate”. In General terms, the charity rebate allows the purchaser of a good and/or service to decide what to do with the associated rebate using a networked computer device. This is in contrast to other rebate programs. It is to be understood that the terms goods and/or services, as used herein, can be used interchangeably. The invention presented is not limited to goods only or services only. Rather, the spirit of the invention is such that a purchase has associated with it a rebate that can be allocated by the purchaser (i.e. consumer, user, etc.).

The charity rebate is offered by participating retailers, consumer products companies, or service providers and redeemed by individual consumers, preferably through a networked computer device. As will be apparent, various devices can be used (e.g. cell phones, pda's) provided the device can interface with a remote host computer.

One embodiment comprises a consumer shopping at a retail outlet, and purchasing goods. The retailer and the maker of goods (or supplier of services) have a pre-established agreement regarding charity rebates. The rebate can be associated with a particular good and/or service or with the total purchase. The rebate associated will depend on the agreement between the retailer and the provider of the good and/or service. Agreements can be established with individual charities prior to the purchase or any other charity can be identified by the consumer and the rebate directed thereto.

Means for identification and tracking of the rebate is employed using known procedures. For example, a code associated with that purchased is entered into a computer database along with a code associated with the consumer. The code associated with the consumer can be a credit card number, a number specially assigned by the retailer, street address, etc. The tracking code can be a bar code, numerical, alphabetical, alphanumeric, etc. Alternatively, the code could be by printed code as on a paper receipt or the transaction could be identified through relation to specific credit, debit, loyalty, or gift cards that have been enrolled administratively through the network management site.

At some point, the charity rebate is then redeemed by the consumer using a computer or other device as described. The consumer registers (i.e. logs on, etc.) on the administration network site (i.e. computer server) and is thereafter associated with the codes of the goods and/or services purchased and the relative charities.

At this point, the consumer is empowered to direct the allocation of funds. The consumer may choose to have the rebate amount paid directly to that consumer or to donate all or a portion thereof to an available charity.

After the consumer directs the allocation of funds, the affected retailer, consumer products company, or service provider associated with the goods and/or services purchased then receives a redemption report from the network administrator. Thereafter, the consumer directives are carried out. As will be apparent, disbursement may be achieved by traditional mail or electronic means either in lump sum or at periodic intervals.

The administrator of the charity rebate tracks all charitable donations made by individual consumers and facilitates tax related activities for all parties involved.

Another embodiment comprises a system whereby user specific information (e.g. credit card number, street address, etc.) is not linked to the product. Rather, codes on the product itself are entered into the server database. Otherwise, the invention is implemented as described elsewhere.

### BRIEF DESCRIPTION OF THE DRAWINGS

FIG. 1 depicts a block diagram illustrating one embodiment of the present invention

FIG. 2 depicts a flow diagram of one embodiment of the present invention

FIG. 3 depicts a block diagram illustrating one embodiment of the present invention

FIG. 4 depicts a flow diagram of one embodiment of the present invention

### DETAILED DESCRIPTION

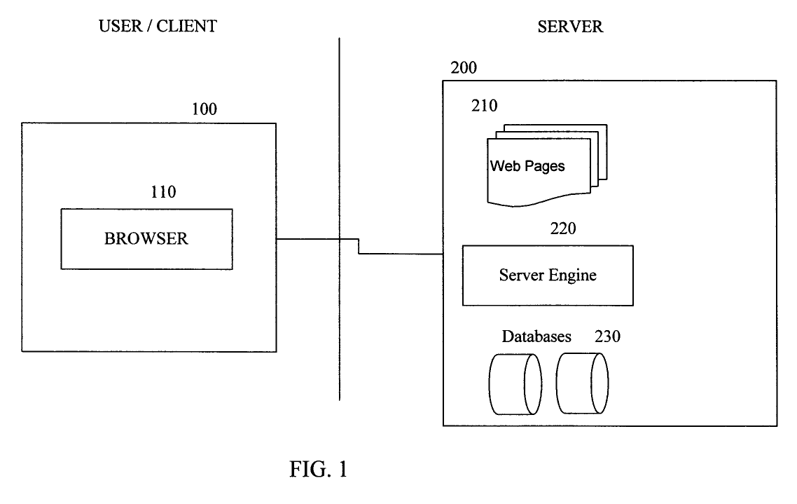

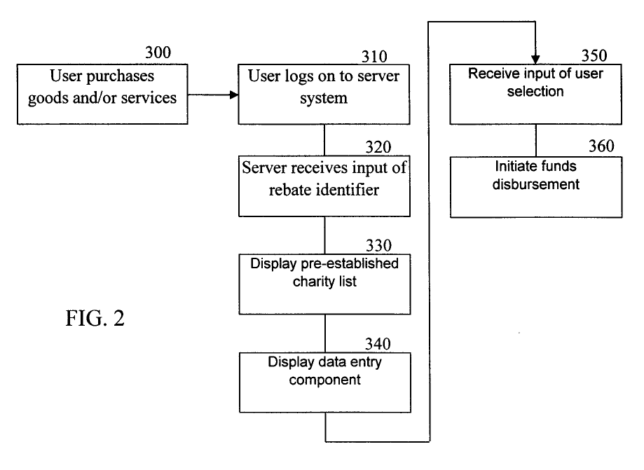

One embodiment (FIGS. 1, 2) for a system and method for efficient allocation of rebates comprises: providing a server system 200 capable of electronic communication with a user in control of a client system 100; enabling (FIG. 2, 300 through 350) the user to selectively apportion a rebate in any proportion among those on the list consisting of the user, charities on a pre-established charity list, and other charities; and initiating 360 a funds disbursement in accordance with the apportionment.

Client system 100 (as well as other client systems disclosed throughout) can be practiced by a user operating a personal computer utilizing a web browser 110. Those of skill in the art will appreciate that other systems are possible to interface with a server system.

Server system 200 (as well as other server systems disclosed throughout) can be practiced by a server engine 220 in conjunction with databases 230 and web page components 210. Those of skill in the art will appreciate that other systems are possible to interface with a client system.

In one embodiment, the step of enabling the user to selectively apportion a rebate in any proportion among those on the list consisting of the user, charities on a pre-established charity list, and other charities comprises receiving 320 a rebate identifier from the client system 100; presenting 330 the pre-established charity list to the client system 100; presenting 340 to the client system a data entry component for designating the user or additional charities not on the pre-established charity list; and receiving 350 from the client system a directive to apportion the rebate associated with the received rebate identifier.

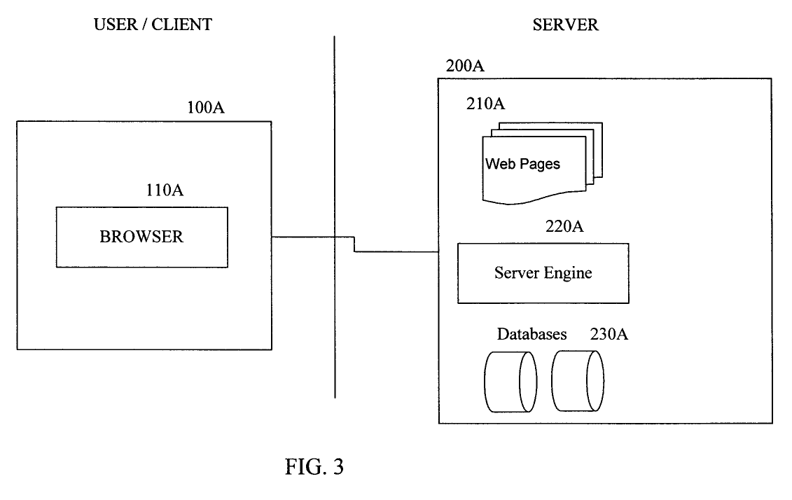

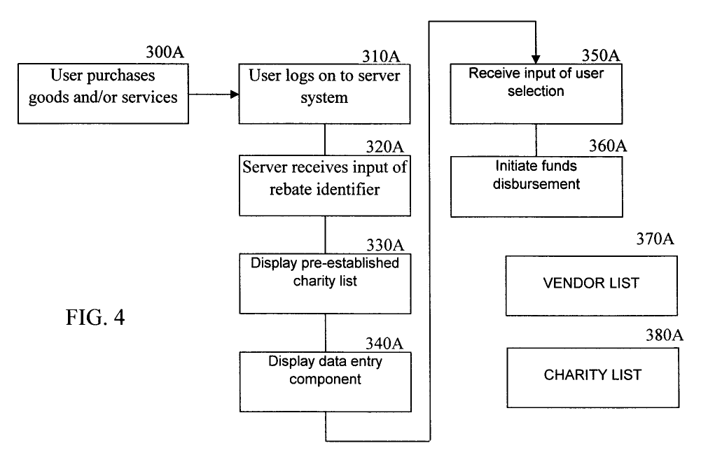

One embodiment (FIGS. 3, 4) for a system and method for efficient allocation of rebates comprises: establishing a list 380A of charities (i.e. charitable organizations and the like); establishing a vendor list 370A; establishing rebates associated with goods and/or services provided by those on the vendor list (each of the rebates having a rebate identifier); providing a server system 200A capable of electronic communication with a client system 100A; receiving 320A a rebate identifier from the client system; presenting 330A the list of charities to the client system; receiving 350A from the client system a directive to apportion the rebate associated with the received rebate identifier; and initiating 360A a funds disbursement according to the directive.

Various alternatives can be implemented regarding the foregoing embodiments disclosed, these alternatives are discussed below.

The client system can record the directives received from the client system. This is advantageous in that data can be analyzed in the aggregate for statistical and marketing purposes.

A user can be assigned a user identifier thus allowing additional capabilities. For instance, a user can have an account and simply choose to deposit rebates into a user account (as opposed to immediately causing a disbursement). The funds can accumulate to eventually be disbursed to charities or the user. All activities (e.g. charities chosen) associated with a particular user can be recorded and utilized for various purposes.

It is contemplated that a rebate be associated with a purchase of a goods and/or services. However, any type of rebate can be used. Each rebate has a rebate identifier associated therewith. This can be practiced by a product label or barcode placed directly on a good (e.g. the box containing a computer peripheral) or in conjunction with a service (e.g. a haircut). The identifier can also be printed on paper or electro-magnetically (or optically) encoded on a plastic card; or electronically transmitted over the internet Those of skill in the art will appreciate that the rebate identifier can be unique or assigned to groups of goods and/or services.

A data entry component can be utilized for designating the user or additional charities not on the pre-established charity list. The purpose being to allow disbursement to charities not listed or alternatively to allow the user to simply keep the rebate for themselves. This can be practiced using a web page interface with dropdown lists or checkboxes. Those of skill in the art will appreciate that other means are possible.

A user (e.g. consumer) can add additional funds to be disbursed along with the original rebate amount. In one embodiment, the additional funds originate from a credit card transaction. The user simply authorizes a charge (the server system can accomplish the electronic transaction or alternatively utilize a third party (e.g. bank or payment processor)) that is added to the rebate amount.

What is claimed is:

1. A method for efficient allocation of rebates comprising the steps of:
providing a server system capable of electronic communication with a user in control of a client system;
enabling the user to selectively apportion a rebate in any proportion among those on the list consisting of the user, charities on a pre-established charity list, and other charities;
initiating a funds disbursement in accordance with the apportionment.

2. The method of claim 1 further comprising:
the rebate being associated with a purchase of a good or service.

3. The method of claim 1 further comprising:
the rebate having a rebate identifier associated therewith.

4. The method of claim 3 further comprising:
the rebate identifier being a bar code.

5. The method of claim 3 wherein the step of enabling the user to selectively apportion a rebate in any proportion among those on the list consisting of the user, charities on a pre-established charity list, and other charities comprises:
receiving a rebate identifier from the client system;
presenting the pre-established charity list to the client system;
presenting to the client system a data entry component for designating the user or additional charities not on the pre-established charity list;
and receiving from the client system a directive to apportion the rebate associated with the received rebate identifier;
whereby the user can selectively apportion a rebate in any proportion among those on the list consisting of the user, charities on a pre-established charity list, and other charities.

6. The method of claim 1 further comprising the step of:
enabling the user to add additional funds to be disbursed.

7. The method of claim 6 further comprising:
the additional funds originating from a credit card transaction.

8. The method of claim 1 further comprising the step of:
recording the directive received from the client system.

9. The method of claim 1 further comprising the steps of:
providing a user identifier;
associating with the user identifier each directive received from that user.

10. A system for efficient allocation of rebates comprising:
a server system capable of electronic communication with a user in control of a client system;
the server system having a computer processor and memory sufficient to enable the server system to perform the steps of,
receiving a rebate identifier from the client system,
the rebate identifier being associated with a rebate,
presenting a pre-established charity list to the client system,
presenting to the client system a data entry component for designating the user or additional charities not on the pre-established charity list,
receiving from the client system a directive to apportion the rebate associated with the received rebate identifier;
and initiating a funds disbursement in accordance with the apportionment.
whereby the user can selectively apportion a rebate in any proportion among those on the list consisting of the user, charities on a pre-established charity list, and other charities.

11. A method for efficient allocation of rebates comprising the steps of:
establishing a list of charities;
establishing a vendor list;
establishing rebates associated with goods and/or services provided by those on the vendor list,
each of the rebates having a rebate identifier;
providing a server system capable of electronic communication with a client system;
receiving a rebate identifier from the client system;
presenting the list of charities to the client system;
receiving from the client system a directive to apportion the rebate associated with the received rebate identifier;
initiating a funds disbursement according to the directive.

12. The method of claim 11 further comprising the step of:
presenting to the client system a data entry component for designating the user.

13. The method of claim 11 further comprising the step of:
presenting to the client system a data entry component for designating additional charities not on the list of charities.

14. The method of claim 11 further comprising:
the rebate being associated with a purchase of a good or service.

15. The method of claim 11 further comprising:
the rebate identifier being a bar code.

16. The method of claim 11 further comprising the step of:
enabling the user to add additional funds to be disbursed.

17. The method of claim 16 further comprising:
the additional funds originating from a credit card transaction.

18. The method of claim 11 further comprising the step of:
recording the directive received from the client system.

19. The method of claim 11 further comprising the steps of:
providing a user identifier;
associating with the user identifier each directive received from that user.
